(19) United States
(12) Patent Application Publication
(10) Pub. No.: US 2025/0124524 A1
(43) Pub. Date: Apr. 17, 2025

(54) SYSTEM AND METHOD FOR CONNECTING PEOPLE

(71) Applicant: BEBER INC, Dover, DE (US)

(72) Inventor: Daniil Komkov, Santa Clarita, CA (US)

(21) Appl. No.: 18/485,276

(22) Filed: Oct. 11, 2023

(51) Int. Cl. G06Q 50/00; G06K 7/14

(52) U.S. Cl. CPC G06Q 50/01; G06K 7/1413; G06K 7/1417

(57) ABSTRACT

The present invention may be a system and/or method for connecting people, such as in forming romantic relationships. A system application may be implemented on computing devices of users. Users may create user profiles using the system application and link physical user cards to their profiles. Users may then meet other users in person and exchange physical user cards. Each user card may have a machine-readable medium that may be scanned using the system application or an auxiliary application. When one user scans the machine-readable medium of a user card of another user using the system application, a connection may be formed between the user profiles of said users, and the machine-readable medium that was scanned may be deactivated whereby it cannot be scanned again.

### BACKGROUND OF THE INVENTION

The present invention relates to systems and methods for connecting people, such as but not limited to systems and methods for forming networking connections, friendships, and romantic relationships. In preferred embodiments, the present invention relates to systems and methods for connecting people in the form of dating (forming romantic relationships).

There are dating systems that exist as applications implemented on devices such as smartphones and the like. Such systems allow users to create profiles on the applications and form connections with profiles of other users if they are interested in forming a romantic relationship with said other users. The connection of user profiles within the systems is generally fully electronic. The connection of user profiles within the systems may occur without the users ever meeting face-to-face.

There are other dating systems that utilize cards or other physical means to encourage users to meet face-to-face before forming a connection within the system. The technology of these cards or other physical means is generally simple and prone to security risks, fraud, and misuse.

### SUMMARY OF THE INVENTION

The present invention may be a system for connecting people. The present invention may also be a method for connecting people. The term “connecting people” as used herein may refer to forming a non-physical connection (i.e. relationship) between two humans. Similar terms may be but are not limited to “introducing people”, “forming an acquaintance”, and “forming a relationship”. The system for connecting people and the method for connecting people described herein may connect people for the purpose of networking (forming professional relationships), friendship, or dating (forming romantic relationships). In preferred embodiments, the system and method for connecting people may be used for dating. The system of the present invention (which may be referred to simply as “the system” herein) may be used by a plurality of people (“users”). The method of the present invention (which may be referred to simply as “the method” herein) may be carried out be a plurality of people (“users”), as well as automated processes involving the transfer of non-transient, computer-readable media between computing devices and a central database.

The system for connecting people may utilize a central database to store information in the form of non-transient, computer-readable media. The central database may store data using one or more servers, each with one or more hard disks and one or more memories (referring to the hardware “memory” component known in the art of servers). The system may utilize multiple central databases and therefore may not be limited to only one central database.

A system application may exist in the form of non-transient, computer-readable media. The system application may be implemented on a plurality of computing devices. Each user of the system may have their own computing device. A computing device may be any machine capable of sending, receiving, and analyzing non-transient, computer-readable media, as well as converting said non-transient, computer-readable media to human-readable text/graphics and displaying said human-readable text/graphics on a display of the computing device. Examples of a computing device may be but are not limited to a smartphone, tablet, laptop computer, or desktop computer. The non-transient, computer-readable media of the system application may contain instructions, which, when executed by the computing devices of the users, may cause the computing devices to transfer non-transient, computer-readable media, receive non-transient-computer-readable media, and convert non-transient, computer-readable media to human-readable text/graphics that are then displayed on the displays of the computing devices.

Each user of the system may have a user profile in the system application. A user profile may be a collection of non-transient, computer-readable media stored in the central database. A user profile may appear as a collection of human-readable text/graphics that are displayed on a computing device when a user accesses their user profile via the system application using said computing device. The user profile of each user may be unique. The user profile of each user may be protected via a password, fingerprint scan, or other security measure whereby only a single user may access their own user profile, and whereby said single user may not access the user profile of any other user. Each user may create and customize their own user profile using the system application.

A plurality of user cards may each have a machine-readable medium. The term “medium” when used in the context of a machine-readable medium configured on a user card refers to a single source of information, such as a single barcode. The term “media” when used in the context of machine-readable media configured on user cards refers to multiple sources of information, such as multiple barcodes. The term “media” when used in the context of non-transient, computer-readable media refers to information that is able to be analyzed by a computer, such as computer code. The machine-readable medium of each of the plurality of user cards may be unique. The machine-readable medium of each of the plurality of user cards may contain a link to a user profile. Multiple machine-readable media may be linked to a single user profile. However, each individual machine-readable medium may only be linked to a single user profile.

The machine-readable medium of a user card may be a 1D barcode. A 1D barcode is a machine-readable representation of information, such as but not limited to numbers, characters, and graphics. A 1D barcode is a rectangular image containing vertical dark lines configured in a horizontal pattern against a light background. In preferred embodiments, the dark lines are black, and the light background is white.

The machine-readable medium of a user card may alternatively be a 2D barcode. A 2D barcode is a machine-readable representation of information, such as but not limited to numbers, characters, and graphics. A 2D barcode is a square image containing dark pixels or “modules” arranged in a pattern against a light background within the square confines of the 2D barcode. In preferred embodiments, the dark modules are black, and the light background is white. The term “2D barcode” as used herein may by synonymous to the term “data matrix” used in the field of machine-readable media.

Both 1D and 2D barcodes are “scanned” (read by a machine) using a laser scanner, which is a specialty device used to read barcodes. Examples of laser scanners are barcode guns in the checkout aisle of a supermarket. Advantages of 2D barcodes over 1D barcodes may include but are not included to the ability to store a larger amount of information, the ability to be configured smaller than 1D barcodes, the ability to be scanned faster than a 1D barcode, and the ability to display information without the use of an external database.

The machine-readable medium of a user card may alternatively be a Quick Response code (“QR code”). A QR code is a machine-readable representation of information, such as but not limited to numbers, characters, and graphics. A QR code is a square image containing dark pixels or “modules” arranged in a pattern against a light background within the square confines of the QR code. In preferred embodiments, the dark modules are black, and the light background is white. The square shape of a QR code has four corners. In each of three of the four corners of a QR code, a dark square is configured within a light square with a dark border. In preferred embodiments, the dark square is black, the light square is white, and the dark border is black. Unlike 1D barcodes and 2D barcodes, QR codes are scanned using 2D imagers. 2D imagers may be more readily available to most users than laser scanners. An example of a 2D imager is a camera implemented on a smartphone. Besides being able to be read by 2D imagers, additional advantages of QR codes over 1D barcodes and 2D barcodes may include but are not included to the ability to store a larger amount of information, the ability to be scanned faster than 1D barcodes and 2D barcodes, the ability to be scanned when partially obscured, and the ability to contain customized graphics made of the modules of the QR codes. Advantages of 2D barcodes over QR codes may include but are not limited to the ability to be configured smaller than QR codes and a greater ability to store structured/encoded data. In preferred embodiments of the present invention, the machine-readable media of the user cards may be QR codes due to their ability to store structured/encoded data.

One or more of the plurality of user cards may belong to a first user of the system, and may thereby be referred to as “first user cards”. The first user may give a first user card to a second user of the system. The second user may scan the machine-readable medium of the first user card using an auxiliary application implemented on a second user computing device. The auxiliary application may be an application implemented on a computing device that is a different application than the system application. An example of an auxiliary application may be a camera application of a smartphone. When the second user scans the machine-readable medium of the first user card using the auxiliary application of the second user computing device, the user profile of the first user may be displayed on the second user computing device. Because the second user has only scanned the machine-readable medium of the first user card using an auxiliary application and not the system application, a third user may now also scan the machine-readable medium of the first user card.

The second user may scan the machine-readable medium of the first user card using the system application implemented on the second user computing device. When the second user scans the machine-readable medium of the first user card using the system application, a connection may be formed between the user profile of the first user and the user profile of the second user. This connection may allow the first user and second user to view each other's profiles at any time. This connection may also allow the first user and second user to send messages to one another using the system application. The system application may prompt the first user and second user to message one another within the system application when a connection is formed between the user profiles of the first user and second user. The connection between these two user profiles may be recorded in the central database. The attempt by the second user to scan the machine-readable medium of the first user card using the system application may be recorded in the central database. When the second user scans the machine-readable medium of the first user card using the system application, the machine-readable medium of the first user card may be deactivated whereby in cannot be scanned by any device using any application. Any machine-readable media of the system may be deactivated if an attempt to scan said machine-readable media is made using the system application.

When the second user scans the machine-readable medium of the first user card using the auxiliary application of the second user computing device and the user profile of the first user is displayed on the second user computing device, the system application may prompt the second user to connect to the user profile of the first user. If the second user declines this prompt, a third user may now also scan the machine-readable medium of the first user card. If the second user accepts this prompt, a connection may be formed between the user profile of the first user and the user profile of the second user, and the machine-readable medium of the first user card may be deactivated whereby in cannot be scanned by any device using any application. The attempt to connect to the user profile of the first user may be recorded in the central database.

Users may link user cards to user profiles using a Link Card function of the system application. To use the Link Card function, users may scan the machine-readable media of their user cards using the system application before any other device has scanned said machine-readable media. A prompt may appear on the users' user devices asking the users to link the cards they just scanned to their user profiles. When accepting said prompt, the machine-readable media of the user cards may be linked to the users' user profiles. Links between machine-readable media of user cards and user profiles may be recorded in the central database.

In some embodiments, the non-transient, computer-readable media of the user profiles may be stored in the central database before users link their user profiles to the machine-readable media of the user cards. This ensures that only the machine-readable media provided on the user cards are linked to user profiles. In other words, machine-readable media generated by users themselves are not able to be used in the system since the data to be encoded in the machine-readable media is uploaded to the central database before it is mapped to the machine-readable media.

Links between machine-readable media and user profiles, connections between user profiles, and attempts to scan machine-readable media may be recorded in the central database. Said recording may occur automatically by the system application sending information to the central database in the form of non-transient, computer-readable media.

A central database may be provided as part of the method for connecting people. A system application may be provided. The system application may be the same system application that has been described herein. The system application may be implemented on a first user computing device and a second user computing device. A first user may create a user profile within the system application. A second user may create a user profile within the system application. The user profile of the second user may be different than the user profile of the first user.

A first user card may be provided to the first user. The first user card may have a machine-readable medium. The first user may use a Link Card function of the system application to link the first user card to the user profile of the first user. Said link may be recorded in the central database.

The first user may provide the first user card to the second user. The second user may scan the machine-readable medium of the first user card using an auxiliary application implemented on the second user computing device. The auxiliary application may be a different application than the system application. The user profile of the first user may be displayed on the second user computing device. The machine-readable medium of the first user may then be scanned by a third user.

The second user may scan the machine-readable medium of the first user card using the system application implemented on the second user computing device, thereby forming a connection between the user profile of the first user and the user profile of the second user. Said connection may be recorded in the central database. The attempt by the second user to scan the machine-readable medium of the first user card using the system application may also be recorded in the central database. The machine-readable medium of the first user card may be deactivated whereby it cannot be scanned by any application using any device.

In some embodiments, a plurality of first user cards may be provided to the first user. Each of the plurality of first user cards may have a unique machine-readable medium. The first user may link at least one of the plurality of first user cards to the user profile of the first user using the Link Card function of the system application.

When the second user scans the machine-readable medium of the first user card using the auxiliary application, the second user may be prompted to connect to the user profile of the first user. The second user may choose not to connect to the user profile of the first user, whereby the machine-readable media of the first user card may be scanned by a third user. Alternatively, the second user may choose to connect to the user profile of the first user, whereby a connection is formed between the user profiles of the first user and second user, and whereby the machine-readable medium of the first user card is deactivated. The connection between the user profiles of the first user and second user may be recorded in the central database. The attempt by the second user to connect to the user profile of the first user may be recorded in the central database.

When a connection is formed between the user profiles of the first user and second user, the first user and second user may be prompted to message each other within the system application.

### BRIEF DESCRIPTION OF THE FIGURES

FIG. 1 is a front view of a user card with a QR code as a machine-readable medium.

FIG. 2 is a front view of a user card with a 2D barcode as a machine-readable medium.

FIG. 3 is a front view of a user card with a 1D barcode as a machine-readable medium.

FIG. 4 is a diagram showing a system for connecting people.

FIG. 5 is a flowchart showing a method for connecting people.

FIG. 6 is a continuation of the flowchart from FIG. 5.

FIG. 7 is a continuation of the flowchart from FIG. 6.

### DETAILED DESCRIPTION

The description provided herein describes example embodiments of the present invention and is not intended to limit the invention to any particular embodiment, feature, component, step, method, software, hardware, overall design, or any other property. Furthermore, the drawings provided herein show example embodiments of the present invention and are not intended to limit the invention to any particular embodiment, feature, component, step, method, software, hardware, overall design, or any other property.

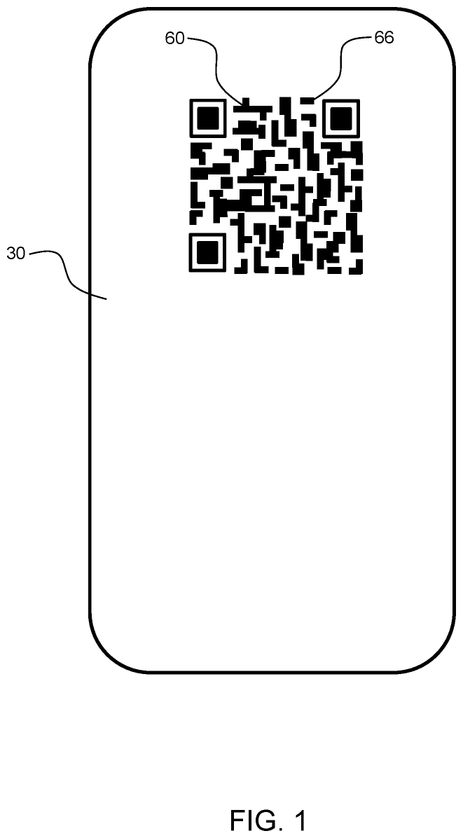

As shown in FIG. 1, a user card 30 has a machine-readable medium 60 in the form of a QR code 66. The QR code 66 shown in FIG. 1 is a square barcode with black modules configured against a white background. Three corners of the QR code 66 have dark squares configured inside of light squares with dark borders. The fourth corner of the QR code 66 comprises black modules against a white background similar to the other portions of the QR code.

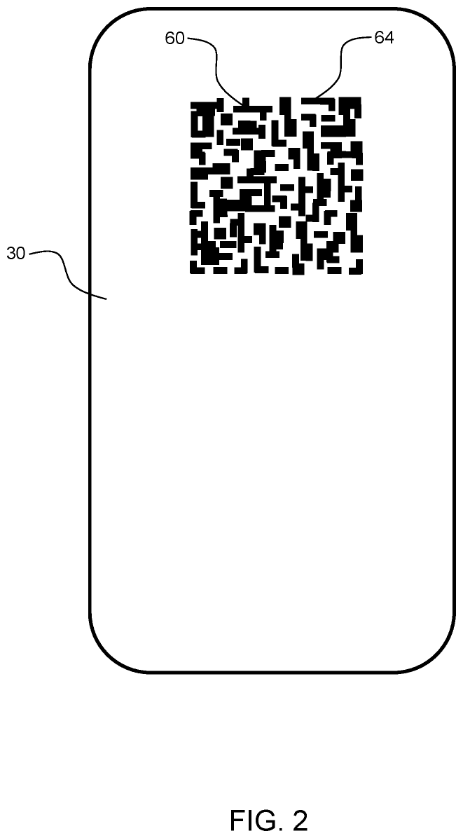

As shown in FIG. 2, a user card 30 has a machine-readable medium 60 in the form of a 2D barcode 64. The 2D barcode 64 shown in FIG. 2 is a square barcode with black modules configured against a white background. Unlike the QR code of FIG. 1, the 2D barcode 64 of FIG. 2 does not have the dark squares configured inside of light squares at three of its corners.

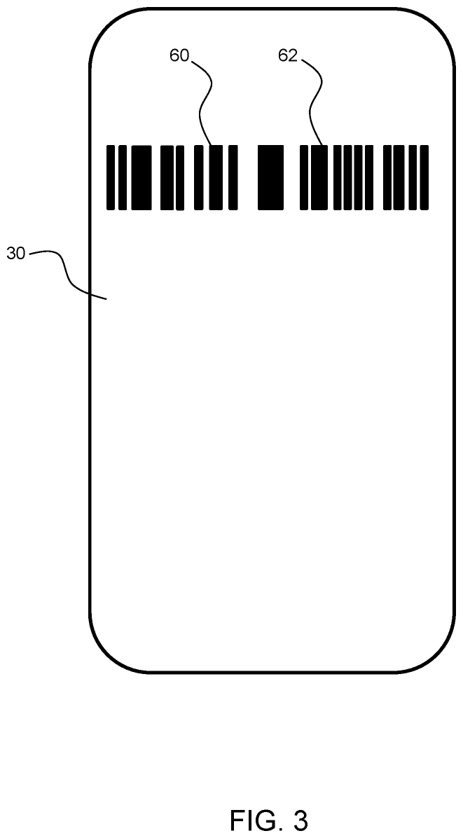

As shown in FIG. 3, a user card 30 has a machine-readable medium 60 in the form of a 1D barcode 62. The 1D barcode 62 shown in FIG. 3 is a rectangular barcode with vertical black lines arranged side-by-side in a horizontal pattern against a white background.

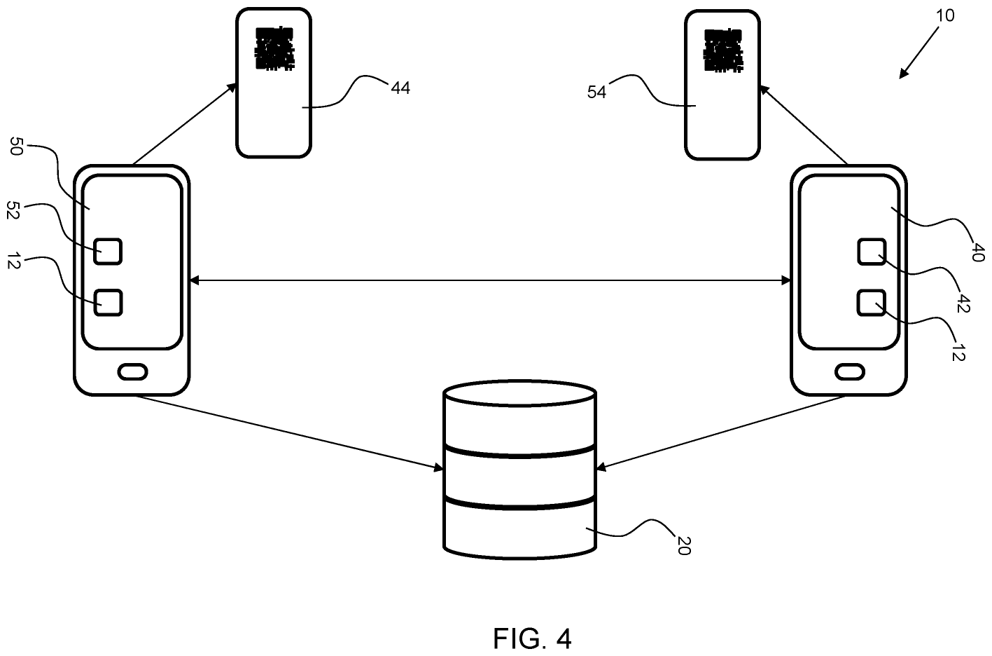

As shown in FIG. 4, a system for connecting people 10 connects user profiles of a system application 12 implemented on a first user computer device 40 and a second user computing device 50. An auxiliary application 42 is also implemented on the first user computing device 40. An auxiliary application 52 is also implemented on the second user computing device 50. The auxiliary application 42 of the first user computer device 40 and the auxiliary application 52 of the second user computing device 50 may be the same application or different applications. However, both the auxiliary application 42 of the first user computer device 40 and the auxiliary application 52 of the second user computing device 50 are different applications than the system application 12.

The system application 12 or the auxiliary application 52 of the second user computing device 50 may be used to scan a first user card 44. The system application 12 or the auxiliary application 42 of the first user computing device 40 may be used to scan a second user card 54. When the system application 12 of the second user computing device 50 is used to scan the first user card 44, a connection is formed between the user profiles of a first user and a second user within the system application 12. This connection is recorded in a central database 20. Likewise, when the system application 12 of the first user computing device 40 is used to scan the second user card 54, a connection is formed between the user profiles of the first user and the second user within the system application 12. This connection is recorded in the central database 20. The system application 12 may communicate with the central database 20 wirelessly via a wireless local area network, wireless personal area network, wireless metropolitan area network, wide area network, radio, or any other wireless network capable of transferring information from a computer to a database in the form of non-transient, computer-readable media.

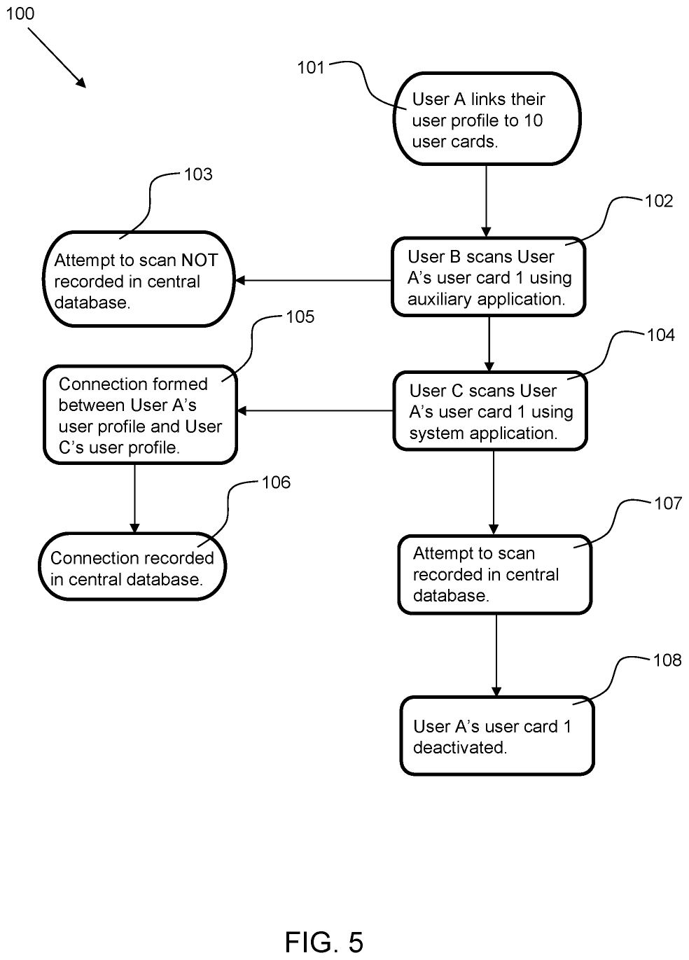

As shown in FIG. 5, a user (User A) links a user profile to ten (10) different user cards 101 as part of a method for connecting people 100. A different user (User B) scans one of User A's user cards (user card 1) using an auxiliary application 102. User B's attempt to scan User A's user card 1 is not recorded in the central database 103. A third user (User C) then scans User A's user card 1 using the system application described herein 104. A connection is formed between User A's user profile and User C's user profile 105 within the system application, and said connection is recorded in the central database 106. User C's attempt to scan User A's user card 1 is recorded in the central database 107, and User A's user card 1 is deactivated 108.

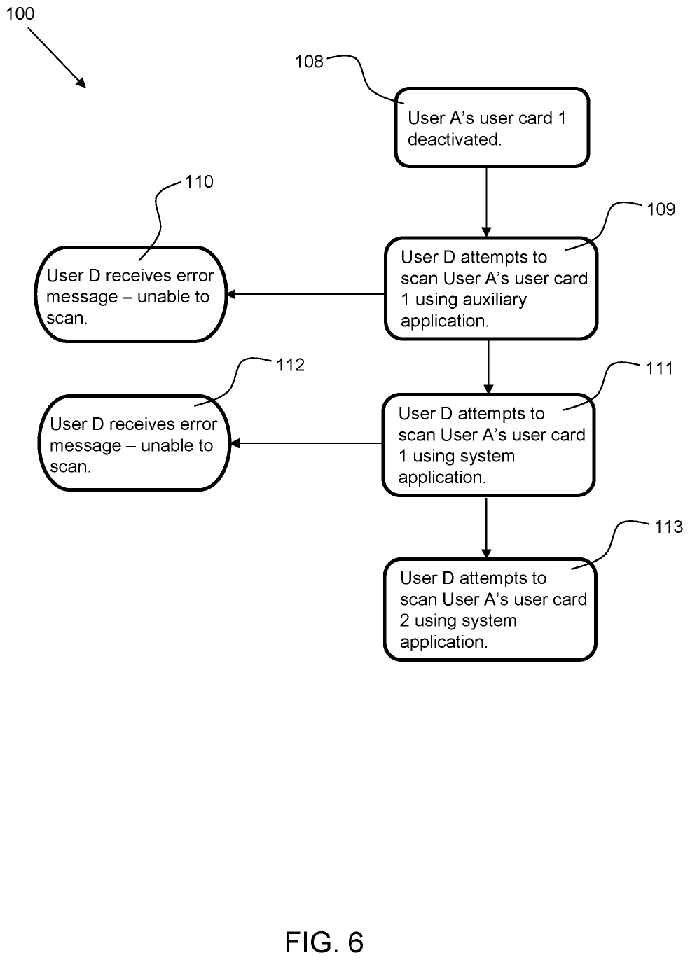

As shown in FIG. 6, as a continuation of the method for connecting people 100 shown in FIG. 5, a fourth user (User D) attempts to scan User A's user card 1 using an auxiliary application 109 after User A's user card 1 has been deactivated 108. User D receives an error message 110 on User D's computing device. The error message may say “Unable to Scan”, or something similar whereby User D is informed that they cannot scan User A's user card 1 using the auxiliary application.

User D then attempts to scan User A's user cards 1 using the system application 111 after User A's user card 1 has been deactivated 108. Again, User D receives the error message 112. User D then attempts to scan another one of User A's user cards (user card 2) using the system application 113.

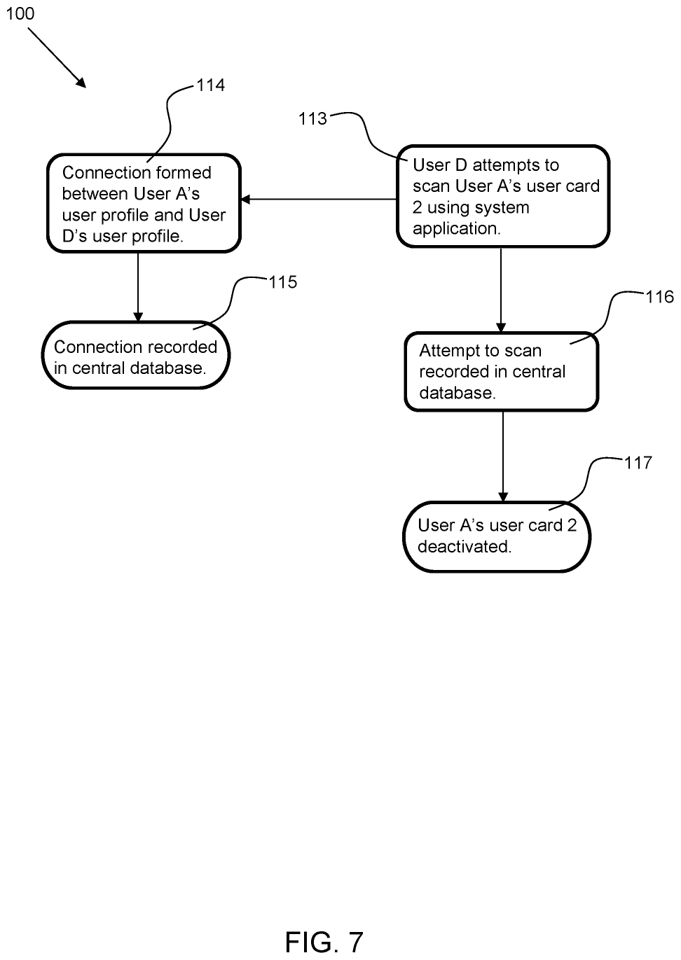

As shown in FIG. 7, as a continuation of the method for connecting people 100 shown in FIGS. 5 and 6, a connection is formed between User A's user profile and User D's user profile 114 within the system application after User D scans User A's user card 2 using the system application 113. Said connection is recorded in the central database 115. User D's attempt to scan User A's user card 2 is recorded in the central database 116, and User A's user card 2 is deactivated 117.

What is claimed is:

1. A system for connecting people comprising:
a central database;
a system application implemented on a computing device of each user of the system, the system application comprising a user profile for each user; and
a plurality of user cards, each comprising a machine-readable medium,
wherein the machine-readable medium on each of the plurality of cards is unique,
wherein the user profile of each user is unique,
wherein each machine-readable medium is linked to a user profile,
wherein one or more of the plurality of user cards are first user cards belonging to a first user,
wherein the first user gives a first user card to a second user,
wherein the second user scans the machine-readable medium of the first user card using an auxiliary application implemented on a second user computing device, the auxiliary application being a different application than the system application,
whereby the user profile of the first user is displayed on the second user computing device,
wherein the machine-readable medium of the first user card is scanned by a third user,
wherein the second user scans the machine-readable medium of the first user card using the system application implemented on the second user computing device,
whereby a connection is formed between the user profile of the first user and the user profile of the second user,
whereby the machine-readable medium of the first user card is deactivated whereby it is no longer able to be scanned,
wherein the links between machine-readable media and user profiles are recorded in the central database,
wherein connections between user profiles are recorded in the central database,
wherein attempts to scan the machine-readable media of each of the plurality of user cards using the system application are recorded in the central database,
whereby a machine-readable medium is deactivated if an attempt to scan said machine-readable medium is made using the system application.

2. The system of claim 1, wherein multiple machine-readable media are linked to a single user profile.

3. The system of claim 1, wherein each machine-readable medium is linked to only a single user profile.

4. The system of claim 1, wherein the machine-readable media are linked to user profiles using a Link Card function of the system application.

5. The system of claim 1, wherein when the second user scans the machine-readable medium of the first user card using the auxiliary application, the system application prompts the second user to connect to the user profile of the first user,
wherein the second user chooses not to connect to the user profile of the first user,
whereby the machine-readable medium of the first user card is scanned by the third user.

6. The system of claim 1, wherein when the second user scans the machine-readable medium of the first user card using the auxiliary application, the system application prompts the second user to connect to the user profile of the first user,
wherein the second user chooses to connect to the user profile of the first user,
whereby the attempt to connect to the user profile of the first user is recorded in the central database,
whereby a connection is formed between the user profile of the first user and the user profile of the second user,
whereby the machine-readable medium of the first user card is deactivated,
whereby the machine-readable medium of the first user card is no longer able to be scanned.

7. The system of claim 1, wherein the machine-readable media are 1D barcodes.

8. The system of claim 1, wherein the machine-readable media are 2D barcodes.

9. The system of claim 1, wherein the machine-readable media are QR codes.

10. The system of claim 1, wherein when the connection is formed between the user profile of the first user and the user profile of the second user, the first user and second user are prompted by the system application to message one another within the system application.

11. The system of claim 1, wherein the user profile of a user is recorded in the central database prior to the machine-readable medium being linked to said user profile.

12. A method for connecting people comprising:
providing a central database;
providing a system application implemented on a first user computing device and a second user computing device;
a first user creating a user profile within the system application;
a second user creating a user profile within the system application, wherein the user profile of the second user is different than the user profile of the first user;
providing a first user card to the first user, the first user card comprising a machine-readable medium;
the first user using a Link Card function of the system application to link the first user card to the user profile of the first user;
recording the link between the first user card and the user profile of the first user in the central database;
the first user providing the first user card to the second user;
the second user scanning the machine-readable medium of the first user card using an auxiliary application implemented on the second user computing device, the auxiliary application being a different application than the system application,
whereby the user profile of the first user is displayed on the second user computing device,
wherein the machine-readable medium of the first user card is scanned by a third user;
the second user scanning the machine-readable medium of the first user card using the system application implemented on the second user computing device;
forming a connection between the user profile of the first user and the user profile of the second user;
recording the connection between the user profile of the first user and the user profile of the second user in the central database;
recording the attempt by the second user to scan the machine-readable medium of the first user card using the system application in the central database; and
deactivating the machine-readable medium of the first user card.

13. The method of claim 12, wherein a plurality of first user cards are provided to the first user,
wherein each of the plurality of first user cards comprise a unique machine-readable medium,
wherein the first user links at least one of the plurality of first user cards to the user profile of the first user using the Link Card function of the system application.

14. The method of claim 12, further comprising:
prompting the second user to connect to the user profile of the first user when the second user scans the machine-readable medium of the first user card using the auxiliary application,
wherein the second user chooses not to connect to the user profile of the first user,
whereby the machine-readable medium of the first user card is scanned by the third user.

15. The method of claim 12, further comprising:
prompting the second user to connect to the user profile of the first user when the second user scans the machine-readable medium of the first user card using the auxiliary application;
the second user choosing to connect to the user profile of the first user;
forming a connection between the user profile of the first user and the user profile of the second user;
recording the connection between the user profile of the first user and the user profile of the second user in the central database;
recording the attempt by the second user to scan the machine-readable medium of the first user card using the system application in the central database; and
deactivating the machine-readable medium of the first user card.

16. The method of claim 12, wherein the machine-readable medium is a 1D barcode.

17. The method of claim 12, wherein the machine-readable medium is a 2D barcode.

18. The method of claim 12, wherein the machine-readable medium is a QR code.

19. The method of claim 12, further comprising:
prompting the first user and second user to message one another within the system application when the connection is formed between the user profile of the first user and the user profile of the second user.

20. The method of claim 12, further comprising:
recording the user profile of the first user in the central database before the first user links the user profile of the first user to the first user card.
